(19) United States
(12) Patent Application Publication
(10) Pub. No.: US 2007/0239520 A1
(43) Pub. Date: Oct. 11, 2007

(54) Motivational apparatus and method of motivation

(76) Inventor: Devin Collins, Binghamton, NY (US)

Correspondence Address: BROWN & MICHAELS, PC;400 M & T BANK BUILDING, 118 NORTH TIOGA ST, ITHACA, NY, 14850, US

(21) Appl. No.: 11/394,577

(22) Filed: Mar. 31, 2006

(51) Int. Cl. G06F 11/34

(52) U.S. Cl. 705/11

(57) ABSTRACT

The method and apparatus stimulate performance improvement and provide performance recognition. The method and apparatus serve to communicate goals, missions, and objectives; stimulate action that involves interactive communication, organization and reinforcement; and identify and promote performance to individuals, teams, or any other association of people. The customizable apparatus includes a means to stimulate mental and physical action through the defining and tracking of data, psychological reinforcement, and performance feedback. Information pertaining to a goal, mission, and objective of the sponsor is collected and presented to the user via the apparatus. The user is then stimulated toward the goal through a user-determined course of action developed within the apparatus, which allows the user to take action steps toward the desired goal. The user's performance toward the desired goal is tracked through the apparatus and computer applications. This data is entered into a computer metrics resulting in performance recognition information.

### BACKGROUND OF THE INVENTION

1. Field of the Invention

This invention relates to a method and apparatus for the purpose of stimulating action, performance recognition, goal-achievement, best practice identification and team building. The invention more generally relates to a method and apparatus used by individuals, teams, and other associated people in order to communicate goals, missions, and objectives through an apparatus that serves to innervate and organize a user in order to promote performance, identify best practices, and provide performance recognition.

2. Description of Related Art

Individuals, businesses, and other associations have attempted to improve performance and motivate themselves, employees, and members through various modes of discourse and methods. A primary means of improving performance is through the use of inspiration which comes in the form of speakers, books, audio-recordings, and video cassettes. Simply reading or listening to these inspirational methods of motivation represents a short-term and short-sighted method of improving performance and motivating individuals, teams, or other associations of people. Inspiration and motivation are very different. Inspiration is defined by Webster's Dictionary as “the act or power of moving the intellect or emotions.” Motivation is defined by Webster's Dictionary as “to provide with a motive,” where motive is defined as “moving to action.” Reading a book or listening to a speaker or audio recording does not provide the consumer with motivation, only inspiration. Motivation is the result of an individual's own act toward a desired goal which can only be accomplished by the individual taking action. The process of stimulating a person or persons to mental and physical performance has not been fully addressed in prior art.

Various methodologies and apparatus have been proposed and are publicly available to help people change a behavior. Early approaches have focused on games and mechanical means to influence an individual toward a desired behavior. For example, U.S. Pat. No. 3,290,796 to Gurda (1966) and U.S. Pat. No. 4,776,799 to Walsh (1988) disclose two apparatus that serve as child-training boards with daily goals and interactive methods leading to a reward. Another child training apparatus that is slightly more complex incorporates a mirror and timing systems. U.S. Pat. No. 5,288,233 to Green (1994) discloses a learning device for attention deficit children where the mirror is non-functional and a timer serves to reward children for completing daily tasks under a specified time. These apparatus supply pre-selected courses of action and fail to allow the user to define actions or identify means to performance. These apparatus are also limited to individual use and fail to provide a means of communication to other users or interested parties.

Other inventors have chosen to create motivational and behavioral pattern changing products by transforming calendars and books. U.S. Pat. No. 5,090,733 to Bussiere (1992) discloses a motivational calendar which carries a daily desired behavioral “action” and “thought” coupled with an illustration that modifies with use. This product like those discussed above supplies pre-selected courses of action not determined by the user. The product fails to provide a psychological connection with the user and fails to allow the user a means of developing action steps. U.S. Pat. No. 5,387,107 to Gunter and Williams (1995) discloses a personalized interactive storybook and method of teaching a desired behavior by inserting a picture of the user actually reading the book. This storybook, by inserting the picture of the reader in an illustration depicting the desired behavior, offers psychological connection but again supplies only pre-selected courses of action. The drawback is that the user is allowed no feedback or interaction beyond a personalized picture. This product is also limited in use to the one individual using the product.

The mirror has longed been used for a variety of purposes. The mirror serves a psychological purpose by having the user associate himself or herself with the desired behavior patterns or goals that the user is seeking to achieve. U.S. Pat. No. 4,743,047 to Baer (1988) discloses a book that is combined with a mirror. The device lacks a motivational purpose and provides no means of interaction with the user other than for visual use. U.S. Pat. No. 5,169,316 to Lorman & Jones (1992) discloses a Speech Therapy device that provides direct visual feedback. This device is made up of a mirror surrounded by illustrated lip positions and words to say. The illustrations and words on the device are made of inexpensive material and are disposable after use, which lacks the durability necessary for extended use. This device is not used for a motivational purpose in the sense of interactive goal achievement or improving performance. The user of this device is again supplied with a pre-selected course of action without a means to develop the necessary actions steps to the desired goal. U.S. Pat Application No. 2004/0131996 to Ortiz-Valero discloses a method for selection of individualized personal care products. The device includes a mirror with a plurality of attribute selection sites used as a diagnostic for personal care products. The product fails to consider interaction with other users and is again positioned as only offering pre-selected courses of action within defined product areas. The device is not used to improve performance and or communicate best practices as identified by the user of the device.

The development of computers has led inventors to create methodologies of interactive systems as well as several different methods of learning and goal-achievement involving data collection and analysis. U.S. Pat. No. 5,954,510 to Merril (1999) discloses a method for goal-achievement and learning that assists people in achieving and learning to achieve self-determined measurable goals over time. The user enters data, and metrics are computed which gauge the user's progress towards achieving goals and provide the user with performance feedback. This system fails to acknowledge a stand alone apparatus including an interactive method, a mirror, a timer, and a recorder. This system also lacks a means of communication and feedback based on more than one user, which is necessary for performance improvement by teams and other associations of people. The system also does not consider the desire for competitive analysis between different users and their previous performance.

U.S. Pat. No. 5,967,789 to Segal (1999) discloses a method and system for stopping or modifying undesirable health-related behavior habits or maintaining desirable health-related behavior habits. This method involves a computer and a series of customized visually perceptible messages which establishes a customized regimen. The system lacks an apparatus including an interactive method, a mirror, a communication surface, a timer, and a recorder. The system also fails to recognize the need or desire of the user to develop daily goals and actions, which move the user toward the desired goal and identifies areas of best practices toward performance. This system provides a pre-selected course of action without user definability and interaction.

U.S. Pat. No. 6,565,504 to Blementhal (2003) discloses a method and apparatus to create and induce self-created hypnosis. The user of this method enters preferences into a computer resulting in a customized hypnosis script that is listened to by the user. This system provides only pre-selected courses of interaction where the user is limited to what is suggested by the system. The system lacks an apparatus including a communication medium and a visual medium. The method requires the use of a computer program in order to experience the hypnosis which fails to consider a means of use where a computer would not be necessary.

### SUMMARY OF THE INVENTION

In view of the foregoing, it is clear that a method and apparatus is needed whereby an individual, team, or other association of people are provided with a method and apparatus which functions to allow the user/users to stimulate mental and physical action resulting in desired performance. The method and apparatus stimulates mental and physical action through a process where users define and identify action steps toward a plurality of goals and are motivated and reinforced to performing action steps resulting in an ability to recognize performance, give feedback, and identify best practices.

The invention in its broadest sense preferably includes an apparatus, which in simplest form provides a means to present visual imagery and behavioral suggestions, a means that stimulates the user to create action steps and define goals, a means that stimulates the user to take action steps toward goals, a means to track action steps and goals and finally, a means to recognize performance. The apparatus preferably provides a means through which a sponsor, which could be an individual, business entity, team leader, or any other association of people customizes the method and apparatus according to the desired performance of a particular goal, mission, or objective. The customized method and apparatus stimulate mental and physical action by the user which is an individual, team, or other association of people sharing a desire of performance toward a particular goal, mission, or objective.

The method using this apparatus preferably includes communicating customized data and information from the sponsor of the apparatus to the user or users. The user or users are then preferably stimulated to develop their own course of action toward the desired goal. Once a course of action is developed the user is stimulated to take the action steps through a visual platform provided through the apparatus that communicates, organizes, and reinforces the course of action. The user is stimulated to action through a series of psychological techniques including a mirror, timer, recorder, and calendar. The action steps taken are preferably entered and tracked through the apparatus resulting in recognized previous performance that further stimulates the user toward the desired performance. The user's designed course of action and action steps taken are preferably compiled via the apparatus and accompanying computer application. The data held in the computer application is preferably transferred to a server that compiles the data from the user and other users, which are then, enter in a computer metrics that provides performance recognition.

The purpose of the method and apparatus is to continually stimulate mental and physical action toward a desired level of performance and intended goal. This results in a motivated user throughout the different stages toward the achievement of the goal, mission, or objective. Further, the purpose of the method and apparatus is to allow for the identification of performance and how it was achieved. The objective of the method and apparatus is being able to allow sponsors, users, team leaders, business managers, or any other association of people a means to stimulate mental and physical action in order to improve performance and identify performance in any one of a plurality of potential goals, mission, or objectives.

In a first embodiment, the method motivates a user to achieve a primary objective using a goal tablet including a changeable goal display area and a mirror. The method includes the steps of generating the primary objective for the user, displaying the primary objective in the changeable goal display area, and displaying at least one motivational item on the goal tablet. The method further includes psychologically reinforcing a desire to achieve the primary objective by the user viewing himself or herself in the mirror while viewing, reading, or speaking the primary objective or the motivational item.

In a second embodiment, the apparatus motivates a user to achieve a primary objective. The apparatus includes a goal tablet. The goal tablet includes a mirror positioned on the goal tablet for the user to view himself or herself and a plurality of changeable display areas positioned around the mirror for displaying a plurality of images to be viewed by the user while viewing herself or himself in the mirror. At least one of the changeable display areas is a goal display area for displaying the primary objective:

In a third embodiment, the method motivates each of a plurality of users to achieve a user objective. The method includes the steps of collecting user data from each of the users and collecting sponsor data from at least one sponsor of the users. The method also includes identifying the user objective for each of the users based on the user data and the sponsor data and identifying a plurality of tasks for each of the users toward achieving each of the user objectives. The method further includes tracking completion of the tasks and collecting task completion data from the users for the sponsor and tracking a success rate for each of the users toward achieving the user objective. The method also includes comparing the success rate to the task completion data to identify the tasks correlated with producing success as a plurality of focus tasks. The method further includes the steps of providing the focus tasks to the users, providing the focus tasks to the sponsor, and tracking completion of the focus tasks and collecting focus task completion data from the users for the sponsor.

### BRIEF DESCRIPTION OF THE DRAWINGS

FIG. 1 illustrates a motivational system in an embodiment of the present invention.

FIG. 2 illustrates a method in an embodiment of the present invention.

FIG. 3 illustrates a goal tablet, a goal card, and a goal sheet in an embodiment of the present invention.

FIG. 4 illustrates a goal tablet in an embodiment of the present invention.

FIG. 5 illustrates a goal sheet in an embodiment of the present invention.

FIG. 6 illustrates a goal card in an embodiment of the present invention.

FIG. 7 illustrates a goal tablet in another embodiment of the present invention.

FIG. 8 illustrates a goal tablet with software and computer capabilities in yet another embodiment of the present invention.

### DETAILED DESCRIPTION OF THE INVENTION

Referring now to the drawings of a system, method, and apparatus of the present invention, the invention provides a method for stimulating mental and physical action toward a goal, mission, or objective resulting in improved and recognized performance. The method and apparatus stimulate a user to develop a course of action toward a desirable goal, mission, or objective and then stimulate the user to reach the desired goal, mission, or objective through reinforcement and performance feedback.

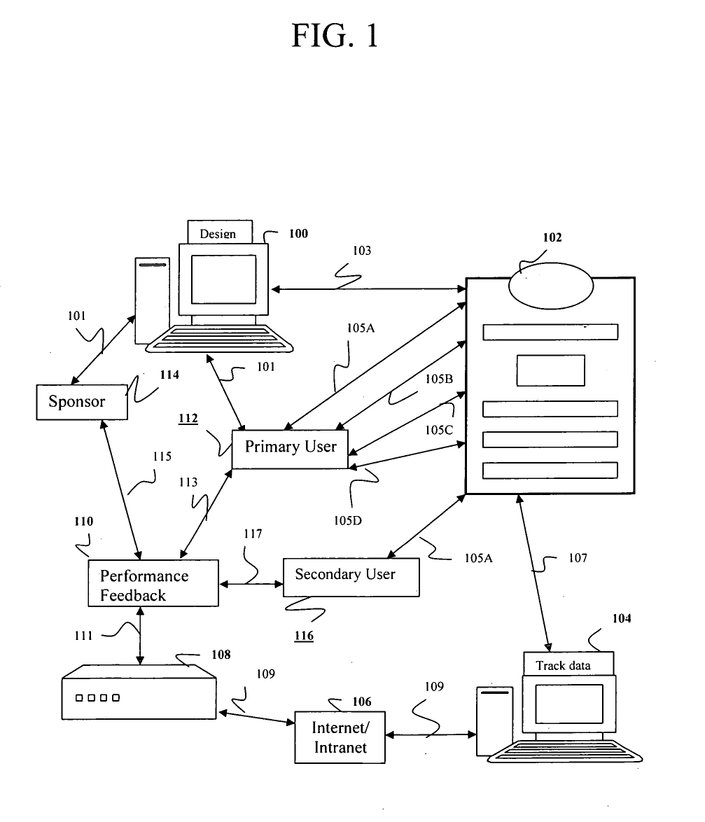

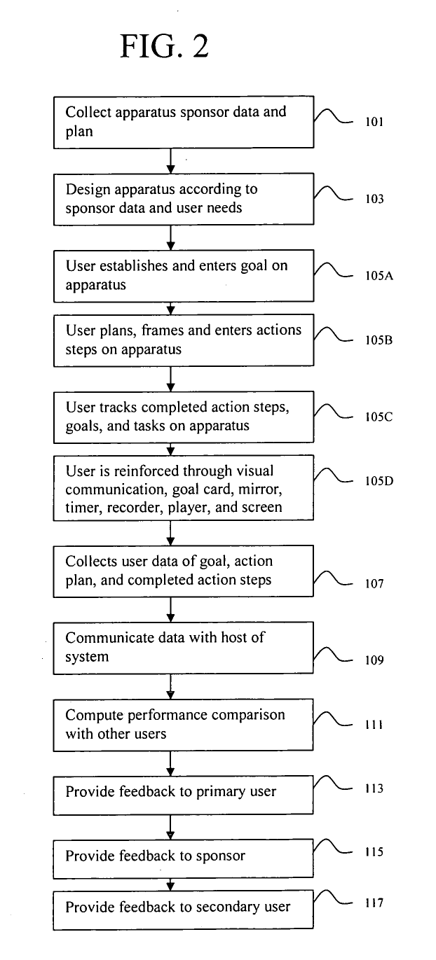

FIG. 1 shows a block diagram of a system including a method and an apparatus in an embodiment of the present invention. FIG. 2 shows method steps, which explain the method sequence from the development of the method and apparatus through its execution. First, sponsor data is collected 101 as specified by the sponsor 114 or the user 112. The apparatus 102 is referred to as a goal tablet 102 throughout the rest of the disclosure. Using a computer 100, the apparatus is designed according to the sponsor data and user needs 103, resulting in a customized the goal tablet 102 and program to be used by the primary user 112 and a secondary user 116.

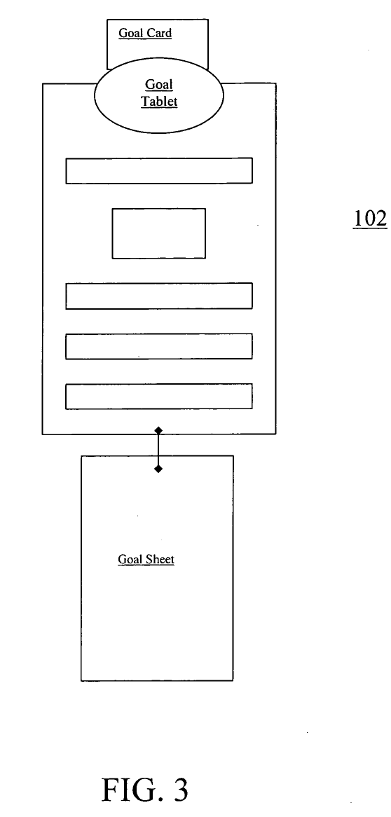

The user/users are provided a means to stimulate mental and physical action 105A-D through the goal tablet 102. First, the user identifies individual courses of action by establishing individual goals 105A. The user frames action steps and develops to the desired goal 105B. Then, the user tracks actions steps accomplished toward desired goal 105C. Finally, the user is stimulated toward action through psychological reinforcement 105D. FIG. 3 is a diagram of the goal tablet 102 illustrating the goal sheet 300 and goal card 400.

Data is collected 107 from the goal tablet 102 and entered into a computer software application 104. The user 112 is able to save and track data collected through computer software application 104. The data in the computer software application 104 is sent 109 using internet/intranet 106. A server 108 receives data of the users 112. This process may be repeated by many users 112 resulting in the server 108 having multiple data from different users using goal tablet 102. The server 108 processes data in a computer metrics 111 resulting in performance feedback data 110. The computer metrics 111 determines performance recognition and best practices of the user/users 112 resulting in performance feedback data 110. The performance feedback data 110 is provided 113 to the user/users 112. The performance feedback data 110 is also provided to the secondary user 116 if a secondary user is necessary 117. The performance feedback data 110 is also provided 115 to the sponsor 114.

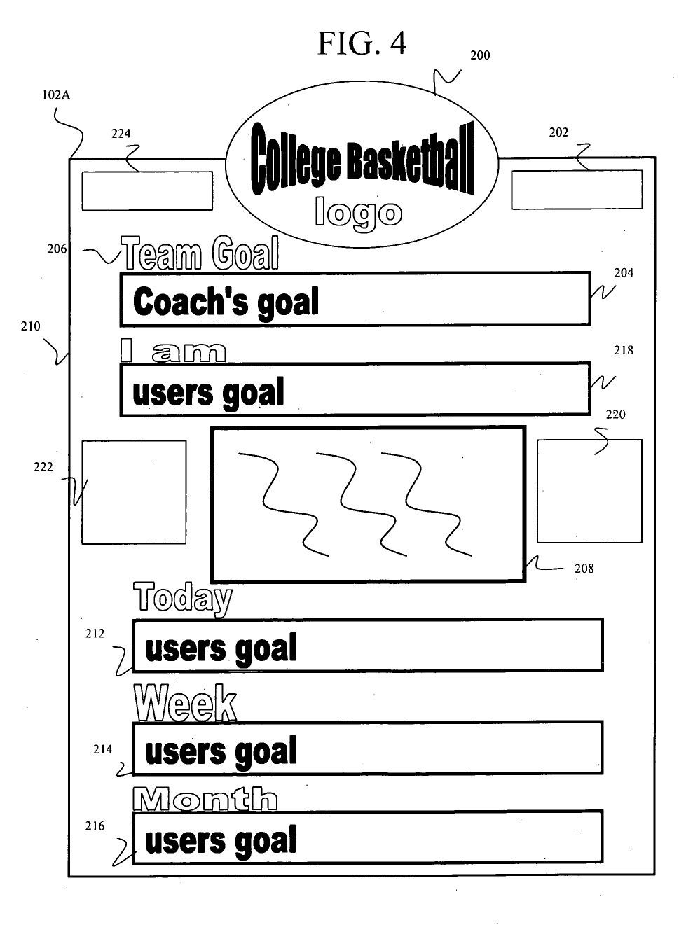

In an embodiment of the present invention, a college athletic director sponsor 114 designs 101, 103 the goal tablet 102 for the user/users of the invention a college basketball where a coach is the secondary user 116 and a basketball player is the primary user 112. The coach 116 in this embodiment may use the goal tablet 102 in conjunction with each individual player on the basketball team. FIGS. 4 to 6 illustrates a goal tablet 102 designed for use by a basketball team.

The goal tablet 102 shown in FIG. 4 may be created by the college athletic director 114. The goal tablet 102 includes means for stimulating the users 112 and 116 to mental and physical action in developing and communicating courses of action toward goals; completing action steps to reaching goals; and receiving reinforcement and feedback along the way 105D. The goal tablet 102 shown in FIG. 3 is made of a suitable material such as plastic, wood, or metal which can be mounted on a wall or other suitable surface. The goal sheet 300 and goal card 400 of the goal tablet 102 also illustrated in the diagram are made of suitable materials that can be written on and erased by the user and as well as printed on permanently according to sponsor requirements.

The embodiment of FIG. 4 shows a goal tablet 102A according to the design of the college athletic director 114 to be used to create team unity, stimulate mental and physical action toward team and individual goals, and improve the overall performance of the college basketball team. In logo area 200, the team name is printed in order to identify the school sponsor 114 and use of the goal tablet 102A. Printable areas such as printable area 206 identify and frame what is to be written in the writeable areas as designed by the sponsor 114. Printable areas are present when a writeable area is present. Writeable areas 204, 212, 214, 216, 218 are made of a suitable material that can be written on and removed by the user including, but not limited to, a chalk board material, dry-erase board material, or multi-sheets of removal paper.

The coach 116 identifies the team goal and communicates the team goal 105A through writeable area 204. The basketball player 112 identifies an individual goal and communicates it 105A through writable area 218. The writeable areas 204, 212, 214, 216, 218 and the printable areas accompanying them stimulate mental action in users 112 and 116 by having them identify goals and visually communicate them. The basketball player write and visually communicate actions steps 105B for the day, week, and month in writable areas 212, 214 and 216 respectively. The number of writable areas present on the goal tablet 102A can encompass any number of writeable areas determined by the needs of the sponsor. One aspect of reinforcement provided is mirror surface 208 where the basketball player can view his own face and repeat the goals written in writeable areas 204 and 212 to 218 providing psychological reinforcement 105D. The athletic director sponsor 114 may choose to print motivational items or other information in area 202, 220, 222, 224 if desired, as a source of reinforcement for the player. Motivational items include, but are not limited to, motivational phrases, mission statements, company goals, and motivational images.

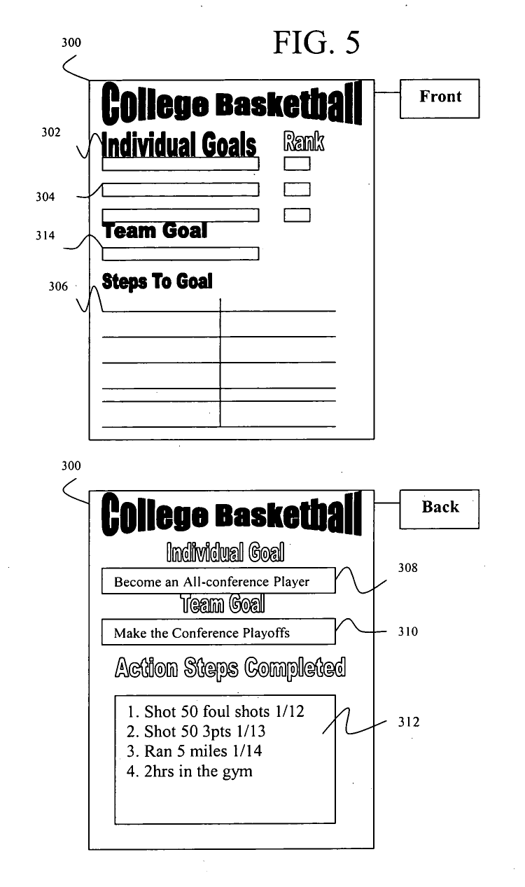

The embodiment of FIG. 5 shows the goal sheet 300 part of the goal tablet 102. In designing 101 the athletic director 114 determines the use and specifics of the goal sheet 300. In this embodiment the athletic director 114 determined the goal sheet 300 would allow the basketball coach 116 and the player 112 to plan courses of action for the season. The goal sheet 300 has writable areas 304 and 306 where the user frames and writes the action steps 105B to be completed to reach the coach's and individual goals written in writeable areas 204 and 218. The goal sheet 300 serves as a planning mechanism for stimulating the mental or physical action steps toward a defined goal, mission, or objective. The action steps written in writeable area 306 are then written in writeable areas 212, 214, and 216. The goal sheet 300 has writeable areas 308, 310 and 312 where the user tracks completed action steps and goals 105C. The goal sheet 300 serves to stimulate the development of a plan toward the goal. The goal sheet 300 reinforces and gives feedback by visually communicating the plan and tracking the results, all of which stimulate action. In the embodiment of the basketball team writable area 306 identifies the basketball player's 112 goal that is also communicated through writable areas 302 and 218. Writable area 310 identifies the coach's 116 team goal that is also communicated in writable areas 314 and 204. Writable area 312 identifies 105B and tracks 105C actions steps completed by the basketball player 112 resulting in the stimulation of action.

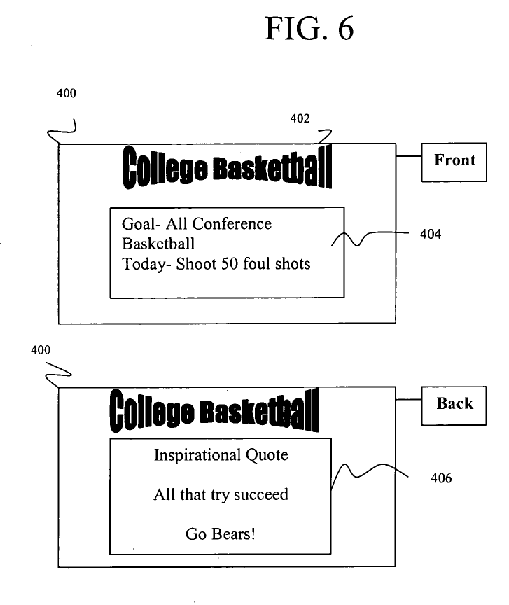

The embodiment of FIG. 6 shows the goal card 400 part of the goal tablet 102. The goal card 400 is used to reinforce the basketball player user 112. The goal card 400 can be removed from the goal tablet 102 and carried on the basketball player 112. In logo area 402 the basketball team logo is printed to identify the sponsor and create team unity. The basketball player 112 writes the goal from 204 in writable area 404 representing further reinforcement 105D. The basketball player 112 carries the goal card 400 with him when away from the physical goal tablet 102. The college athletic director sponsor 114 prints inspiration or other information in printable area 406 as a source of reinforcement to stimulate action.

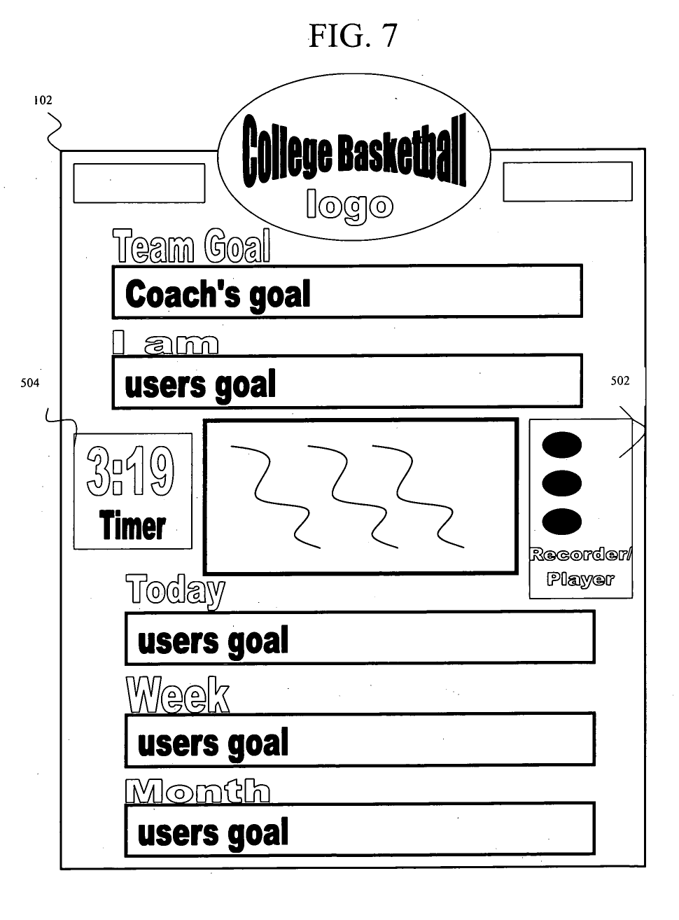

The embodiment of FIG. 7 shows the goal tablet 102 with further embodiments to provide reinforcement 105D. The user records on voice recorder and speakers 502 information that is played back to reinforce the intended goal. The basketball player 112 records on recorder 502 inspirational sayings or other relevant information that reinforces the basketball goals. In an alternate embodiment, information is prerecorded as determined by the sponsor to serve as reinforcement. Advice from alumni basketball players on team goals would be recorded on recorder 502 which serves as a reinforcement stimulating action. The timer 504 introduces a time element including a clock or calendar that tracks the number of days, hours, or other specified time increments until a goal is to be reached or an action step is to be completed. The timer 504 reinforces the goal 105D which stimulates action. In this embodiment, the device establishes time lines for the user to accomplish certain action steps or goals. The basketball team may choose to have a timer in preseason counting down the number of days until the first game which reinforces desired goals and stimulates the basketball team to immediate action.

In an embodiment of a full cycle of the invention, the basketball players 112 enter their goals and action steps 107 from goal tablet 102 into computer application 104. The data entered is sent to a host 109 and performance comparisons are computed 111 resulting in performance feedback 110. In the basketball team embodiment, the performance feedback 110 identifies what each player accomplished during the season as related to their goals and action steps taken 105A-D. The performance feedback 110 identifies the players with the highest shooting percentage and their common goals and action steps. This performance feedback allows the coach 116 to identify the best practices of those players 112 with high shooting percentages. The resulting performance feedback information 110 stimulates other players 112 to take similar action steps in order to reach the same results.

Although the description has been directed to a sports team where the sponsor is an athletic director and the coach and players are the secondary and primary users, it is understood that the system and apparatus are useful in other situations as well. For example, the sponsor may be the National Institute of Health and the primary user may be a person at risk for diabetes. In another embodiment, the sponsor is rehabilitation clinic, the secondary user is a drug counselor, and the primary user is a recovering addict. Alternately, the sponsor may be a consultant, where the human resources manager is the secondary user, and the engineers are the primary users. The goal for the consultant is to introduce, reinforce, and gather feedback on a total quality management program where the users are stimulated to mentally and physically take action to implement the new program.

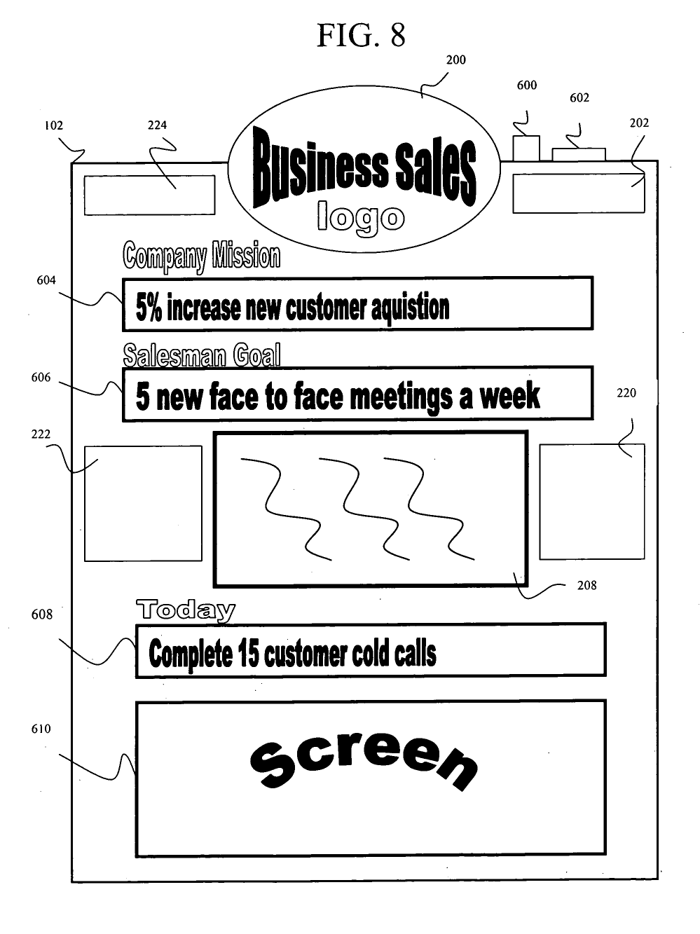

The goal tablet 102 shown in FIG. 8 has electronic and networking capabilities. The data transfer device 600 represents a network connection through an analog, ISDN (Integrated Services Digital Network), DSL (Digital Subscribers Line), cable, or any other form that accomplishes similar tasks. The data input connection 602 represents a connection for data entry through a keyboard, SmartQuil, or other similar input device. Digital display screens 604, 606, 608 and 610 replace the writing areas 204, 218, 212 and 216. The display screens 604, 606, 608 and 610 may be utilized through data connection 602 or a handwriting recognition technology. The digital display screens 604, 606, 608 and 610 serve the same purpose as the writing areas with the added capabilities to communicate information and data directly to the computer 104 as well as the capability for performance feedback 110 to be presented via the digital display screens 604, 606, 608 and 610 on goal tablet 102 in the forms of text, videos, multimedia graphs, and other visual analytical tools.

The following describes an embodiment of this invention illustrating one design of the goal tablet 102 shown in FIG. 8. In this embodiment, the goal tablet 102 with electronic and networking capabilities is sponsored by a business executive 114 to be used by members of the sales force 112.

Data is collected 101 from the business 114, using a computer 100. A performance feedback program 110 and goal tablet 102 are designed according to the business 114 needs 103. The business 114 in this embodiment has designed the goal tablet 102 determining the need for the computer screens 604, 606, 608 to be used as the medium of communication to transfer goals, missions, and data. The computer screens 604, 606, 608 communicate and transfer data from a business executive 114 to an employee 112 to a computer 104 to a server 108 then back to business executive 114 and employee 112. In this embodiment the first computer screen 604 provides data to the salesman 112 from the business executive 114 on the immediate mission of the sales force, which is to “Increase new customer acquisition by 5% for the month”, as presented on computer screen 604. The second computer screen 606 is used by the employee 112 to enter and present an individual goal to obtain “5 new face to face meetings a week” 105A. The third computer screen 608 communicates the daily action step taken by the employee 112, which for this day is to make “15 cold calls to new customers” process step 105B. This information is transferred by a data transfer device 600 to computer 104 and moving data to computer 104. The employee 112 could use data input connection 602 or handwriting recognition technology on the computer screen 610 to enter data on customer acquisitions. If entered through data input 602 the employee 112 would type in the information on the new customer. If entered through the computer screen 610 the employee 112 would electronically write on the screen the new customer information. This data would be transferred to computer 104. The electronic capabilities of the goal tablet 102 allows for the elimination of the goal sheet 300. The user planning, framing, and entering action steps 105B and the user tracking completed action steps, goals, and tasks 105C may take place through the goal tablet 102. In this embodiment, the goal sheet 300 and goal card 400, if used, may be designed in accordance with the mission of increasing new customer acquisitions by 5% as established by business executive 114. The mirror 208 is used to reinforce the individuality of the employee 112 by allowing the employee to view herself in the mirror while viewing and repeating executive and individual goals, which provides psychological reinforcement process step 105D. The business executive 114 may also provide inspirational or other information in printing areas 202, 220, 222 and 224 resulting in reinforcement 105D. The steps of establishing a goal 105A, planning actions 105B, tracking actions 105C, and receiving reinforcement 105D all serve to stimulate the user to mental and physical action toward the desired goal.

The data and information collected through the goal tablet 102 as a result of establishing a goal 105A, planning actions 105B, and tracking actions 105C is now held and organized in computer 104. The data is communicated 109 through the internet 106 to server 108. At that point the data and information are compiled in a computer metrics 111 resulting in performance feedback 110. In this embodiment, the performance feedback 110 gives the business executive 114 detailed information on the sales people who met the goal for new customer acquisitions, identifying the action steps they completed compared to the other sales people that failed to meet the goal. This performance feedback 110 highlights top performers and best practices. The employee 112 receives performance feedback throughout the process to the business goal via graphs on her computer screen 610 illustrating her performance relative to other sales people. The communication of the performance information is not limited to the goal tablet 112. It may be provided via the use of any output device such a as a facsimile machine, cell phone, blackberry, computer, etc.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of motivating a user to achieve a primary objective using a goal tablet comprising a changeable goal display area and a mirror, the method comprising the steps of:
a) generating the primary objective for the user;
b) displaying the primary objective in the changeable goal display area;
c) displaying at least one motivational item on the goal tablet; and
d) psychologically reinforcing a desire to achieve the primary objective by the user viewing himself or herself in the mirror while viewing, reading, or speaking the primary objective or the motivational item.

2. The method of claim 1 further comprising the steps of collecting user data from the user and collecting sponsor data from a sponsor of the user, wherein the goal tablet is designed and the primary objective is generated based on the user data and the sponsor data.

3. The method of claim 2, wherein the user data and the sponsor data are collected on at least one computer.

4. The method of claim 2 further comprising the step of generating a plurality of tasks to be completed toward achieving the primary objective based on the primary objective.

5. The method of claim 4 further comprising the step of displaying the tasks on a goal sheet mounted to the goal tablet.

6. The method of claim 4 further comprising the steps of tracking completion of the tasks and collecting task completion data in an electronic database.

7. The method of claim 4 further comprising the steps of comparing user performance to a plurality of peers of the user based on the task completion data and providing feedback to the user on a progress of the user toward achieving the primary objective and on how the user compares to the peers to motivate the user further toward achieving the objective.

8. The method of claim 7 further comprising the step of providing feedback to the sponsor on the progress of the user toward achieving the primary objective and on how the user compares to the peers.

9. The method of claim 1 further comprising the steps of the user carrying a goal card when the user is away from the goal tablet and the user reading the goal card when the user is away from the goal tablet, wherein the goal card comprises a display of the primary objective and a display of at least one action to be done toward achieving the primary objective.

10. The method of claim 1 further comprising the steps of recording an audio message on an audio message recorder on the goal tablet and playing the audio message to the user.

11. The method of claim 1 further comprising the step of counting down to a deadline time using a timer on the goal tablet.

12. An apparatus for motivating a user to achieve a primary objective comprising:
a goal tablet comprising:
a mirror positioned on the goal tablet for the user to view himself or herself, and
a plurality of changeable display areas positioned around the mirror for displaying a plurality of images to be viewed by the user while viewing herself or himself in the mirror;
wherein at least one of the changeable display areas is a goal display area for displaying the primary objective.

13. The apparatus of claim 12, wherein the plurality of images are selected from the group consisting of:
a) text;
b) multimedia graphs; and
c) pictures.

14. The apparatus of claim 12, wherein the goal tablet further comprises a timer for counting down to a deadline time.

15. The apparatus of claim 12, wherein the goal tablet further comprises an audio recorder and audio player for recording and playing messages as audio messages.

16. The apparatus of claim 12, wherein the goal tablet further comprises an indicia display area for displaying a team indicia or a company indicia of the user.

17. The apparatus of claim 12, wherein the plurality of changeable display areas further comprise:
a user goal display area for displaying a user goal defined by the user;
a sponsor goal display area for displaying a sponsor goal defined by a sponsor of the user; and
at least one of a daily, weekly, or monthly user sub-goal display area for displaying a daily, weekly, or monthly sub-goal to be reached toward achieving the primary objective.

18. The apparatus of claim 12, wherein the plurality of changeable display areas are selected from the group consisting of:
a) a dry-erase board;
b) a chalk board; and
c) a multi-sheet paper.

19. The apparatus of claim 12, wherein the plurality of changeable display areas comprise electronic displays.

20. The apparatus of claim 19 further comprising at least one computer in communication with the goal tablet, wherein the computer controls what is displayed in the plurality of changeable display areas.

21. The apparatus of claim 12 further comprising a goal sheet comprising:
an individual goal display area for displaying an individual goal for the user;
a group goal display area for displaying a group goal for a group comprising the user;
a task display area for displaying a plurality of tasks directed to be done toward achieving the primary objective; and
a completed task display area for displaying a plurality of completed tasks of the tasks;
wherein the goal sheet is located at a goal sheet display area of the goal tablet.

22. The apparatus of claim 12 further comprising a goal card comprising:
a display of the primary objective; and
a display of at least one action to be done toward achieving the primary objective;
wherein the goal tablet further comprises a goal card display area for the goal card to be placed when the user is in proximity to the goal tablet; and
wherein the goal card is carried on the user as a reminder for the user of the primary objective and the action when the user is away from the goal tablet.

23. A method of motivating each of a plurality of users to achieve a user objective, the method comprising the steps of:
a) collecting user data from each of the users;
b) collecting sponsor data from at least one sponsor of the users;
c) identifying the user objective for each of the users based on the user data and the sponsor data;
d) identifying a plurality of tasks done by each of the users toward achieving each of the user objectives;
e) tracking completion of the tasks and collecting task completion data from the users for the sponsor;
f) tracking a success rate for each of the users toward achieving the user objective;
g) comparing the success rate to the task completion data to identify the tasks correlated with producing success as a plurality of focus tasks;
h) providing the focus tasks to the users;
i) providing the focus tasks to the sponsor; and
j) tracking completion of the focus tasks and collecting focus task completion data from the users for the sponsor.

24. A method of motivating each of a plurality of users to achieve a user objective, the method comprising the steps of:
a) collecting user data from each of the users;
b) collecting sponsor data from at least one sponsor of the users;
c) identifying the user objective for each of the users based on the user data and the sponsor data;
d) identifying a plurality of tasks for each of the users toward achieving each of the user objectives;
e) tracking completion of the tasks and collecting task completion data from the users for the sponsor;
f) tracking a success rate for each of the users toward achieving the user objective;
g) comparing the success rate to the task completion data to identify the tasks correlated with producing success as a plurality of focus tasks;
h) providing the focus tasks to the users;
i) providing the focus tasks to the sponsor; and
j) tracking completion of the focus tasks and collecting focus task completion data from the users for the sponsor.
